(19) United States
(12) Patent Application Publication
(10) Pub. No.: US 2018/0157492 A1
(43) Pub. Date: Jun. 7, 2018

(54) MEMORY ACCESS CONTROL FOR PARALLELIZED PROCESSING

(71) Applicant: Centipede Semi Ltd., Netanya (IL)

(72) Inventors: Nadav LEVISON, Herut (IL); Noam MIZRAHI, Hod-Hasharon (IL)

(21) Appl. No.: 15/366,009

(22) Filed: Dec. 1, 2016

(51) Int. Cl. G06F 9/38; G06F 9/30

(52) U.S. Cl. CPC G06F 9/3838; G06F 9/30043

(57) ABSTRACT

A processor includes a hardware-implemented pipeline and parallelization circuitry. The pipeline processes program code. The parallelization circuitry creates a first (earlier) segment and a second (later) segment of the program code to be processed in parallel. Each segment is an ordered sequence of instructions within the program code. A last store to a memory address is identified in the first segment. During parallelized processing of the first segment and the second segment, the parallelization circuitry controls second segment loads which are potentially dependent on the last store by: during processing of the first segment instructions, providing a release notification when the memory address is available for subsequent instructions, and, during processing of the second segment instructions, issuing a second segment load which is potentially dependent on the last store for execution after the release notification is provided.

### FIELD AND BACKGROUND OF THE INVENTION

The present invention, in some embodiments thereof, relates to parallel processing of code instructions and, more particularly, but not exclusively, to resolving memory dependencies during parallel processing.

Many processors execute instructions out of order speculatively. If a load instruction is executed before a preceding store instruction and there is at least one overlapping byte between the two addresses, the address will return incorrect data. This memory order violation is usually detected when the store is executed, and is typically handled by flushing and re-executing the load and all of the following instructions.

Memory order violations (also denoted load before store violations) may degrade performance, therefore aggressive out-of-order processors typically implement a predictor which will prevent the violating instructions from executing out of program order in the future. These predictors are usually program counter (PC) based, and are usually located in the front end of the processor where instructions flow in their original order. The predictor identifies load and store instructions which had an order violation in the past and causes them to execute in the original program order.

Many methods for forcing load and store instructions to execute in their original order are known. For example, a load which is predicted to create a memory violation may be stalled until all older stores are executed (or at least their memory addresses are known). This method is known as “bad loads”. Another method is to create a “barrier” on a store which is predicted to create a memory order violation by stalling all younger loads until the store is executed. This method is known as “store barrier”.

Examples of techniques for handling memory order violations include:

A. Moshovos, S. Breach, T. N. Vjaykumar and G. Sohi present a technique for handling data dependencies by instruction-level parallel (ILP) processors in “Dynamic Speculation and Synchronization of Data Dependencies” in the Proceedings of the 24^{th} Annual International Symposium on Computer Architecture, 1997. They propose a speculation mechanism that attempt to predict those instructions whose immediate execution is going to violate a true data dependence and to delay the execution of those instructions only as long as is necessary to avoid the mis-speculation.

S. Stone, K. Woley, K. Malik, M. Agarwal, V. Dhar and M. Frank speculative techniques for handling inter-thread data dependencies in “Synchronizing Store Sets (SSS): Balancing the Benefits and Risks of Inter-thread Load Speculation” in Technical Report CRHC-06-14, University of Illinois, Center for Reliable and High-Performance Computing, December 2006, which is incorporated herein in by reference in its entirety. The paper describes store set synchronization which predicts store-load dependences using store sets and enforces those predicted dependences using renaming and scheduling techniques.

### SUMMARY OF THE INVENTION

During parallelized processing, violations due to data dependencies may occur. For example, load before store (LBS) violations occur when a load instruction is executed before a preceding store instruction with overlapping addresses has executed and thus a wrong value is loaded.

Embodiments of the invention address LBS violations in which the load and store instructions are located in different segments of the program code. A release notification mechanism is used to prevent a load operation in a later segment of code from issuing for execution before the memory address is available (e.g. before the last store in an earlier segment of code was issued).

A store instruction in an earlier segment may cause an LBS violation to occur when a load instruction is processed in a later segment (e.g. the last store and the load involve overlapping memory address). A store instruction may be suspected of causing an LBS violation even if it does not necessarily write to the designated address (even partially), as long as the possibility that an LBS violation may occur has been established or is suspected.

As used herein the term “last store” means the store instruction which triggers the release notification which is required to issue load instruction(s) in the later segment. If the earlier segment contains a single store that experienced an LBS violation with the second segment load, then that store is considered the last store. If the earlier segment contains multiple stores that experienced an LBS violation with the same second segment load, then the final violating store in segment 1 is the last store.

Optionally, when the earlier segment contains multiple stores that experienced an LBS violation with the same load in the second segment, each of these multiple stores is assigned a different respective notification. The release notification for the last store may be triggered only after these respective notifications have been provided. This effectively creates a “chain” of notifications within the earlier segment, so that only after all notifications in the chain have been provided is the last store release notification triggered. Thus, when a load instruction in the later segment waits for the release notification for the last store it effectively waits for all of the stores in the earlier segment which may potentially cause an LBS for the load.

Detection of the last store instruction may be performed by any means known in the art, for example by analyzing the program code before processing and/or by monitoring processing of the code instructions.

As used herein the term “memory address is available for subsequent instructions” means that when a subsequent instruction (e.g. an instruction in a later segment) is executed, the memory address is available for use by the subsequent instruction and an LBS violation will not occur. The release notification may be provided before the memory address is actually available (e.g. before the store instruction is issued), when it is expected that the memory address will be available at the time the subsequent instruction is executed.

Optionally, the availability of the memory address is determined in the issue queue or in the decoder. For example, the release notification may be provided when the last store instruction is issued for execution or when the address calculation is issued.

Load(s) in a later segment which may be (or are suspected may be) involved in an LBS violation with the last store are required to wait for the release notification (e.g. tag) from the last store. These loads are issued for execution only if the release notification has been provided. Thus if the last store and a load in the second segment are processed in the correct order, the load is not delayed. However, if the memory address is not available, the load is not issued and awaits the release notification.

According to an aspect of some embodiments of the present invention there is provided a method for a processor that executes program code with parallel processing. The method includes creating a first ordered sequence of instructions of the program code to be processed as a first segment and a second ordered sequence of instructions of the program code to be processed as a second segment. The second segment is later than the first segment. In the first segment, a last store to a memory address is identified, wherein a load in the second segment is potentially dependent on the last store. During processing of the first segment and the second segment, at least one instruction in the second segment is executed before all instructions in the first segment are decoded. Loads in the second segment which are potentially dependent on the last store are controlled. Controlling loads in the second segment potentially dependent on the last store includes:

during processing of the first segment instructions, providing a release notification when the memory address is available to subsequent instructions; and

during processing of the second segment instructions, issuing the load potentially dependent on the last store for execution after the release notification is provided.

According to some embodiments of the invention, the first segment instruction and the second segment instructions are processed in parallel.

According to some embodiments of the invention, the release notification is provided after the last store is issued for execution.

According to some embodiments of the invention, the method further includes setting, during the processing of the second segment instructions and before the last store is decoded in the first segment, the load potentially dependent on the last store to be released for execution after the release notification is provided.

According to some embodiments of the invention, the release notification is assigned to be released after the last store, independently of assigning the release notification to be awaited by the loads.

According to some embodiments of the invention, the method further includes providing the release notification includes releasing a tag preallocated to the load potentially dependent on the last store.

According to some embodiments of the invention, the method further includes determining, for the last store in the first segment, a tag preallocated to the load potentially dependent on the last store.

According to some embodiments of the invention, providing a release notification includes broadcasting the release notification across at least one of: a plurality of schedulers and a plurality of threads.

According to some embodiments of the invention, the method further includes:

grouping load and store instructions into at least one group, wherein each group respectively includes a store and at least one load which together caused a load before store violation; and

assigning, to each instruction in a group, a respective group identifier of the group.

According to some embodiments of the invention, the method further includes, when a load in the second segment has an assigned group identifier, delaying the issuing of the load for execution only if a store instruction identified by the assigned group identifier is present in the first segment.

According to some embodiments of the invention, the method further includes analyzing the first segment to determine, for each of the groups, a respective count of store instructions in the first segment to the respective memory address of the group.

According to some embodiments of the invention, the method further includes maintaining a store instruction scoreboard for the first segment, wherein the store instruction scoreboard includes, for each of the groups, a respective count of store instructions of the group in the first segment.

According to some embodiments of the invention, identifying a last store includes:

fetching a store instruction having an assigned group identifier from the first segment;

incrementing a respective counter for a group identified by the assigned group identifier; and

establishing the fetched store instruction as the last store when a value of the respective counter equals a respective count for the identified group in the scoreboard.

According to some embodiments of the invention, the method further includes:

maintaining respective tag maps for the first and second segments, wherein a tag map includes a respective tag for each of the groups; and

after the load is decoded in the second segment, checking the second segment tag map for a respective tag for a group which includes the decoded load and waiting for a release of the respective tag before issuing the decoded load for execution.

According to some embodiments of the invention, the method further includes:

maintaining respective tag maps for the first and second segments, wherein a tag map includes a respective tag for each of the groups;

after a store having an assigned group identifier is decoded in the first segment, updating a respective tag of a group identified by the assigned group identifier in the first segment tag map; and

after the decoded store is issued, releasing a notification associated with the respective tag.

According to some embodiments of the invention, the method further includes, after the last store is decoded, assigning to the last store a respective tag previously allocated in the second segment tag map to the group identified by the assigned group identifier.

According to some embodiments of the invention, the method further includes producing an initial second segment tag map from the first segment tag map and a store instruction scoreboard for the first segment, wherein the store instruction scoreboard includes, for each of the groups, a respective count of store instructions for the group in the first segment.

According to some embodiments of the invention, the method further includes producing an initial second segment tag map from the first segment tag map, the producing an initial second segment tag map includes:

for each group with store instructions present in the first segment, assigning an unused tag to the group in the second tag map; and

for each group with store instructions absent from the first segment, copying a respective tag of the group in the first segment tag map to the respective tag of the group in the second tag map.

According to some embodiments of the invention, the method further includes deleting all of the groups according to a deletion policy.

According to some embodiments of the invention, the method further includes providing the release notification when, after completion of decoding of the first segment, a number of store instructions executed to the memory address is less than a total number of store instructions to the memory address in the first segment.

According to some embodiments of the invention, the method further includes, for each group, providing a respective release notification when, after completion of decoding of the first segment, a number of executed store instructions for the group is less than a total number of store instructions for the group in the first segment.

According to an aspect of some embodiments of the present invention there is provided a processor which includes a hardware-implemented pipeline configured to process program code and parallelization circuitry. The parallelization circuitry is configured to create a first ordered sequence of instructions of the program code for processing as a first segment and a second ordered sequence of instructions of the program code for processing as a second segment. The second segment is later than the first segment. In the first segment, a last store to a memory address is identified, wherein a load in the second segment is potentially dependent on the last store. During processing of the first segment and the second segment, at least one instruction in the second segment is executed before all instructions in the first segment are decoded.

Loads in the second segment which are potentially dependent on the last store are controlled by:

during processing of the first segment instructions, providing a release notification when the memory address is available to subsequent instructions; and

during processing of the second segment instructions, issuing the load potentially dependent on the last store for execution after the release notification is provided.

According to some embodiments of the invention, the parallelization circuitry sets, during the processing of the second segment instructions and before the last store is decoded in the first segment, the load potentially dependent on the last store to be released for execution after the release notification is provided.

According to some embodiments of the invention, the parallelization circuitry provides the release notification includes releasing a tag preallocated to the load potentially dependent on the last store.

According to some embodiments of the invention, the parallelization circuitry determines, for the last store in the first segment, a tag preallocated to the load potentially dependent on the last store.

According to some embodiments of the invention, the parallelization circuitry:

groups load and stores instructions into at least one group, wherein each group respectively includes a store and at least one load which together caused a load before store violation; and

assigns, to each instruction in a group, a respective group identifier of the group.

According to some embodiments of the invention, the parallelization circuitry maintains a store instruction scoreboard for the first segment, wherein the store instruction scoreboard includes, for each of the groups, a respective count of store instructions of the group in the first segment.

According to some embodiments of the invention, the parallelization circuitry:

maintains respective tag maps for the first and second segments, wherein a tag map includes a respective tag for each of the groups; and

after the load is decoded in the second segment, checks the second segment tag map for a respective tag for a group identified by a group identifier assigned to the load and waits for a release of the respective tag before issuing the decoded load for execution.

According to some embodiments of the invention, the parallelization circuitry:

maintains respective tag maps for the first and second segments, wherein a tag map includes a respective tag for each of the groups;

after a store having an assigned group identifier is decoded in the first segment, updates the respective tag of a group identified by a group identifier assigned to the store in the first segment tag map; and

after the decoded store is issued, releases a notification associated with the respective tag.

According to some embodiments of the invention, the parallelization circuitry assigns to the last store, after the last store is decoded, a respective tag previously allocated in the second segment tag map to the group identified by the assigned group identifier store.

According to some embodiments of the invention, the parallelization circuitry produces an initial second segment tag map from the first segment tag map, wherein producing an initial second segment tag map includes:

for each group with store instructions present in the first segment, assigning an unused tag to the group in the second tag map; and

for each group with store instructions absent from the first segment, copying a respective tag of the group in the first segment tag map to the respective tag of the group in the second tag map.

According to some embodiments of the invention, the parallelization circuitry provides the release notification when, after completion of decoding of the first segment, a number of store instructions executed to the memory address is less than a total number of store instructions to the memory address in the first segment.

According to an aspect of some embodiments of the present invention there is provided a method for a processor that executes program code with parallel processing. The method includes creating a first ordered sequence of instructions of the program code to be processed as a first segment and a second ordered sequence of instructions of the program code to be processed as a second segment. The second segment is later than the first segment. In the first segment, a last store to a memory address is identified, wherein a store in the second segment is potentially dependent on the last store in the first segment. During processing of the first segment and the second segment, at least one instruction in the second segment is executed before all instructions in the first segment are decoded. Second segment stores potentially dependent on the last store are controlled. Controlling second segment stores potentially dependent on the last store includes:

during processing of the first segment instructions, providing a release notification when the memory address is available to subsequent instructions; and

during processing of the second segment instructions, issuing the second segment store potentially dependent on the last store for execution after the release notification is provided.

According to some embodiments of the invention, the second segment includes a load potentially dependent on the last store, and the method further includes: preventing load before store violations in the second segment between the load potentially dependent on the last store and store potentially dependent on the last store.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified block diagram illustrating an exemplary architecture of a processor with multi-thread parallelized processing, in accordance with embodiments of the invention;

FIG. 2A is a simplified flowchart of a method for controlling second segment load instructions, according to embodiments of the invention;

FIG. 2B is a simplified flowchart of a method for controlling second segment store instructions, according to embodiments of the invention;

FIG. 3 shows an exemplary embodiment of scoreboards for segments of the program code;

FIG. 4 is a simplified flowchart of identifying a last store instruction, in accordance with embodiments of the invention;

FIGS. 5A-5C illustrate an exemplary technique for producing an initial tag map; and

FIG. 6 is a simplified block diagram of a processor, in accordance with embodiments of the invention.

### DESCRIPTION OF SPECIFIC EMBODIMENTS OF THE INVENTION

A data dependency is a situation in which a program instruction refers to the data of a preceding instruction. In order for the program to execute correctly, the data value resulting from the earlier instruction must be available before the later instruction may be processed.

Data dependency problems arise during parallel processing because instructions are not executed sequentially (i.e. in the same order as the coded sequence of instruction). It is therefore possible for an instruction to be ready to load a particular data value from memory before the correct value has been stored by a preceding instruction. If the load instruction does not wait for the preceding store to be completed, a load-before-store (LBS) violation occurs. Recovering from LBS violations is expensive in terms of performance and processing resources and it is extremely desirable to prevent the recurrence of an LBS violation between load and store instructions which have caused such violations in the past. Techniques for identifying instructions which caused LBS violations, managing the dependency and recovering from LBS violations are known in the art for processors where instructions are fetched in order.

In speculative multi-threaded parallelized processors, multiple code segments from a single sequential stream of instructions are fetched, decoded, executed and maybe even committed in parallel. In these processors, load and store instructions from the same code segment and/or from different code segments may be dependent. Violating load and store instructions in the same code segment may be handled as in traditional out-of-order processor, because it is guaranteed that the store instruction will be fetched before the load instruction. However in the case of violating load and store instructions which are in different code segments there is no such guarantee.

Synchronization methods such as “bad loads” and “store barrier” are not suitable for speculative multi-threaded parallelized processors because they may stall execution of many future instructions, even though typically most of them are not really dependent. As a result, the processor has limited ability to process future segments in parallel.

The main challenge in handling memory order violations in multi-threaded parallelized processor comes from the fact that instructions are fetched out of program order. A given load is predicted to be violating only if the matching older store that created this violation in the past is also in the instruction stream. When a predicted violating load is fetched it is possible that:

1) The matching older store is already fetched;

2) The matching older store has not been fetched yet, but will be fetched in the future; and

3) The matching older store is not and never will be fetched (thus this load is actually not violating anything).

One challenge is to identify these cases and handle them properly.

Furthermore, processors usually make younger instructions dependent on older instructions by using an identifier which is associated with the older instructions. This identifier may be re-order buffer (ROB) entry number, target physical register number, Load/Store tag, etc. An additional challenge addressed by embodiments of the invention is to create a dependency between a predicted violating load to an older store which is not fetched yet (or is in the processor pipe and did not arrive to the ROB) and thus has not been assigned any identifier.

Embodiments of the invention manage potential memory order violations more efficiently, by creating an accurate dependency between the two given violating instructions using a release notification process. The release notification prevents LBS violations caused by load and store instructions in different segments of the program code.

In some embodiments, a similar notification process is used to prevent LBS violations by instructions in a single segment of code and/or to cause multiple store instructions to execute in the correct order before the load instruction is issued.

Consider the situation in which two segments are being processed in parallel. It is known that a given load instruction in the later segment (also denoted herein the second segment and segment 2) is potentially dependent on the last store in the earlier segment (also denoted herein the first segment and segment 1). For example, the load instruction in segment 2 has experienced an LBS violation with the last store in the segment 1. The memory address required by the load will not be available until the store instruction in the earlier segment of the program code has been executed. In order to prevent the load instruction in segment 2 from issuing prematurely (e.g. before the correct data is stored in the memory address or before the store address is known), embodiments of the invention require that the load instruction in segment 2 wait for a release notification by the last store in segment 1.

As used herein the term “memory address” means a location in a memory which holds data. The memory address may be specified by any means known in the art.

As used herein, the term “store to a memory address” means storing data to one or more locations in the memory, where the specific locations may be known from the memory address and the type and/or size of the data being stored. Typically, the memory address denotes where the first data byte is stored and any additional data bytes are stored in consecutive locations in the memory.

As used herein, the term “load potentially dependent on the last store” and similar terms means a load from one or more memory locations which may hold data affected by a store in the first segment. It is therefore possible and/or suspected that out of order execution of the store in the first segment and the load in the second segment will cause an LBS violation. Note that this is only potentially true and the real addresses of the store and load may actually be completely different.

Similarly, as used herein, the term “store potentially dependent on the last store” and similar terms means a store to one or more memory locations which may hold data affected by a store in the first segment.

An LBS violation may occur even if the store instruction memory address is not identical to the load instruction memory address. This may occur, for example, when the stored and loaded data are in overlapping locations. Thus a two-byte store to memory address “A” might cause an LBS violation with a load of a double-word from memory address “A-2”.

In optional embodiments of the invention, the release notification is assigned to the loads in the second segment before it is assigned to the last store in the first segment. The load awaits the assigned release notification even if processing has not yet begun on the last store (e.g. the last store was not fetched or decoded yet). When the last store is decoded, the release notification that was previously assigned to the load is assigned to the last store. The assigned release notification is then released after the last store is issued for execution.

In this way the order in which store and load instructions to the same (or partially overlapping) memory address are executed may be controlled in multiple segments of the program code. The memory address is not accessed by the load until it is available, as indicated by the release notification.

The use of release notifications as described herein reduces the recurrence of LBS errors by related store and load instructions in different segments of the program code. Compared to other methods, the wait time before issuing the load in the second segment may be minimized. If the last store instruction has already been issued for execution, there is no wait and the load may be immediately issued for execution.

As used herein the term “program code” means the code instructions as they are listed. During parallel processing, the instructions are not necessarily fetched and/or executed in the order listed in the program code.

The term “logical order” means the order in which program code instructions would be processed if the program code were processed in-order. During out-of-order processing this logical order is not maintained, leading to the possibility of LBS violations.

As used herein the term “trace” means a sequence of instructions in the logical order of a portion of the program code. Traces define a uniquely ordered instruction sequence. A trace may incorporate one or more branch decisions. Although a particular trace may not follow a consecutive sequence of program code instructions, the instructions of the trace are fetched in the order specified by the trace. Typically traces are stored or listed in a data structure (denoted herein the trace database) along with respective data associated with the trace.

As used herein the term “segment” means an ordered sequence of instructions as they are processed through the program code (i.e. not necessarily continuous in terms of the listed program code). During processing of a given segment, the instructions are fetched in the order specified by the segment, although they may be processed out of order.

Optionally at least one of the segments is an instance of a trace. This means that the sequence of instructions specified in the segment corresponds to the sequence of instructions of a trace stored in the trace database. Further optionally, data associated with the trace in the trace database is utilized when the segment is processed. (For example, a scoreboard, as described below, may be stored for the trace and be used when a segment corresponding to the trace is processed.)

In some embodiments, there may be multiple segments which are instances of the same trace.

When segments are created they are given a creation order. The creation order is the logical order in which the segments would be processed if the program code were processed in-order. The terms “earlier segment” and “later segment” refer to the creation order of the segments, so that the earlier segment is created before the later segment is created.

The segments are created in continuous order. This means that the first instruction in segment 2 is the instruction which follows the last instruction of segment 1.

Instructions within a segment are fetched in order. However, the segments may be fetched out of order (and thus overall the fetch is done out of the logical order). For example, instructions may be fetched from segments 1 and 2 simultaneously, so that at least one instruction in segment 2 is fetched before all the instructions in segment 1 are fetched.

It is noted that multiple traces may begin at the same point in the code instructions however different decisions at branch points in the code will cause a different sequence of code instructions to be fetched (i.e. in a different order). Aspects of trace prediction and of identifying a trace using a trace name are described in U.S. patent application Ser. No. 15/079,181 which is assigned to the assignee of the present patent application and is incorporated herein by reference.

Embodiments of the invention are not limited to a particular type of pipeline of the processor. Different types of pipelines have different numbers of stages and different names for the stages. (For example, the classic RISC pipeline includes the steps: instruction fetch, instruction decode and register fetch, execute, memory access and register write back). For clarity, embodiments of the invention use generalized terminology for the pipeline stages as follows:

As used herein the term “fetched” refers to the pipeline portion which brings the instructions from the memory/cache.

As used herein the term “decode” refers the pipeline part which makes an initial understanding of the instruction (e.g., finding destination register and/or finding operands and/or classifying the instruction to a certain family).

As used herein the term “execute” refers the pipeline part which makes the calculation of the instruction.

As used herein the term “issue” refers to the act of moving the instruction to execution.

Exemplary Processor with Parallelization Circuitry

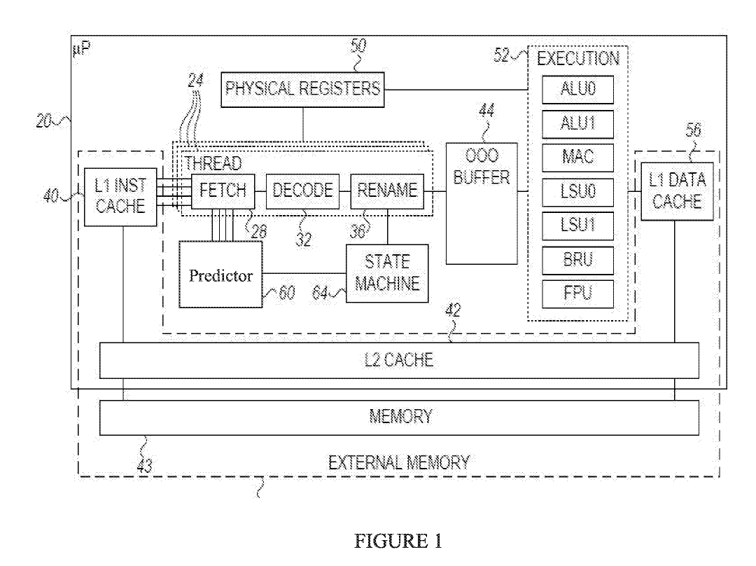

For purposes of explanation, FIG. 1 is a simplified block diagram illustrating an exemplary architecture of a processor with multi-thread parallelized processing, in accordance with embodiments of the invention.

Processor 20 runs compiled software code, while parallelizing the code execution. Instruction parallelization is performed by the processor at run-time, by analyzing the program instructions as they are fetched from memory and processed. In the present example, processor 20 comprises multiple hardware threads 24 that are configured to operate in parallel. Each thread 24 is configured to process a respective segment of the code. (A thread may process multiple segments simultaneously, where each pipe stage handles one or more segments.)

In the exemplary embodiment of the processor, each thread 24 comprises a fetching unit 28, a decoding unit 32 and a renaming unit 36. Fetching units 24 fetch the program instructions of their respective code segments from a memory, e.g., from a multi-level instruction cache. In the present example, processor 20 comprises a memory system 41 for storing instructions and data. Memory system 41 comprises a multi-level instruction cache comprising a Level-1 (L1) instruction cache 40 and a Level-2 (L2) cache 42 that cache instructions stored in a memory 43. Decoding units 32 decode the fetched instructions.

Renaming units 36 carry out register renaming. The decoded instructions provided by decoding units 32 are typically specified in terms of architectural registers of the processor's Instruction Set Architecture. Processor 20 comprises a register file 50 that comprises multiple physical registers. The renaming units associate each architectural register in the decoded instructions with a respective physical register in register file 50 (typically allocates new physical registers for destination registers, and maps operands to existing physical registers).

The renamed instructions (e.g., the micro-ops output by renaming units 36) are buffered in an Out-of-Order (OOO) buffer 44 for out-of-order execution by multiple execution units 52, i.e., not in the order in which they have been fetched by fetching unit 28.

The renamed instructions buffered in OOO buffer 44 are scheduled for execution by the various execution units 52. Instruction parallelization is typically achieved by issuing multiple (possibly out of order) renamed instructions/micro-ops to the various execution units at the same time. In the present example, execution units 52 comprise two Arithmetic Logic Units (ALU) denoted ALU0 and ALU1, a Multiply-Accumulate (MAC) unit, two Load-Store Units (LSU) denoted LSU0 and LSU1, a Branch execution Unit (BRU) and a Floating-Point Unit (FPU). In alternative embodiments, execution units 52 may comprise any other suitable types of execution units, and/or any other suitable number of execution units of each type. The cascaded structure of threads 24, OOO buffer 44 and execution units 52 are an example of a pipeline (as implemented in the architecture by processor 20).

The results produced by execution units 52 are saved in register file 50, and/or stored in memory system 41. In some embodiments the memory system comprises a multilevel data cache that mediates between execution units 52 and memory 43. In the present example, the multi-level data cache comprises a Level-1 (L1) data cache 56 and L2 cache 42.

In some embodiments, the Load-Store Units (LSU) of processor 20 store data in memory system 41 when executing store instructions, and retrieve data from 15 memory system 41 when executing load instructions. The data storage and/or retrieval operations may use the data cache (e.g., L1 cache 56 and L2 cache 42) for reducing memory access latency. In some embodiments, high-level cache (e.g., L2 cache) may be implemented, for example, as separate memory areas in the same physical memory, or simply share the same memory without fixed preallocation.

A predictor 60 predicts branches and/or traces that are expected to be traversed by the program code during execution by the various threads 24. Based on the predictions, predictor 60 instructs fetching units 28 which new instructions are to be fetched from memory. Traces predicted by predictor 60 may be considered a segment or portion of a segment in which LBS violations are prevented according to embodiments of the invention.

When parallelizing the code, a state machine unit 64 manages the states of the various threads 24, and invokes threads to execute segments of code as appropriate.

In some embodiments, the processor parallelizes the processing of program code among multiple threads using one or more elements which are referred to collectively as parallelization circuitry. Parallelization tasks may be distributed or partitioned amongst the various hardware elements of the parallelization circuitry. In the context of exemplary processor 20 units 60, 64, 32 and 36 form the parallelization circuitry. In alternative embodiments, the parallelization circuitry may comprise any other suitable subset of units in the processor.

In some embodiments of a processor, some or even all of the functionality of the parallelization circuitry may be carried out using run-time software. Such run-time software is typically separate from the software code that is executed by the processor and may run, for example, on a separate processing core.

In some embodiments, the parallelization circuitry monitors the code processed by one or more threads, identifies code segments that are at least partially repetitive, and parallelizes execution of these code segments. Certain aspects of thread parallelization are addressed, for example, in U.S. patent application Ser. Nos. 14/578,516, 14/578,518, 14/583,119, 14/637,418, 14/673,884, 20 14/673,889 and 14/690,424, which are all assigned to the assignee of the present patent application and whose disclosures are incorporated herein by reference.

The configuration of processor 20 shown in FIG. 1 is an exemplary configuration that is chosen for the sake of conceptual clarity. In alternative embodiments, any other suitable processor configuration may be used. For example, in the configuration of FIG. 1, multithreading is implemented using multiple fetching, decoding and renaming units. Additionally or alternatively, multi-threading may be implemented in other ways, such as using multiple OOO buffers, separate execution units per thread and/or separate register files per thread. In another embodiment, different threads may comprise different respective processing cores.

As yet another example, the processor may be implemented without cache or with a different cache structure, without branch prediction or with a separate trace and/or branch prediction per thread. The processor may comprise additional elements not shown in FIG. 1. Further alternatively, the disclosed techniques may be carried out with processors having any other suitable microarchitecture.

Processor 20 may be implemented using any suitable 10 hardware, such as using one or more Application-Specific Integrated Circuits (ASICs), Field-Programmable Gate Arrays (FPGAs) or other device types. Additionally or alternatively, certain elements of processor 20 may be implemented using software, or using a combination of hardware and software elements. The instruction and data cache memories may be implemented using any suitable type of memory, such as Random Access Memory (RAM).

Processor 20 may be programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

For clarity, non-limiting embodiments are described below with respect to processing two segments of code. Other embodiments may be used to control load and store instructions performed during parallelized processing of three or more segments.

Embodiments of a method for controlling load and store instructions in segments of program code are now presented. The method is performed in a processor that executes program code. As will be described in more detail below, some or all aspects of embodiments of the invention may be performed and/or controlled by internal processor parallelization circuitry. Alternately or additionally, aspects of embodiments of the invention are performed and/or controlled by external processing elements.

Two or more segments are created in the instruction sequence. Each of the created segments is a respective ordered sequence of instructions to be processed through the program code. Segments are optionally instances of traces, in the sense that instructions within the segment are fetched in the same order as the instructions are listed for the trace. The second segment is the later segment with regards to creation order. Optionally at least one of the segments is an instance of a trace defined using trace prediction during processing of the instruction sequence.

A last store instruction to a memory address is identified in the first segment. At least one load instruction potentially dependent on the last store is present in the second segment. It is noted that the identified last store instruction is not necessarily the last store instruction in the segment, but rather is the last store in the segment from which it is known or suspected that the load instruction may potentially depend.

The two segments are processed in parallel, such that at least one instruction in the second segment is executed before all the instructions in the first segment are decoded. During processing of the first segment, a release notification is provided when the memory address affected by the last store is available. The memory address may indicate multiple locations in the memory, for example when storing multiple bytes of data.

Optionally, the release notification is provided by releasing a tag that was preallocated to at least one load in the second segment potentially dependent on the last store. Embodiments which use tag maps to allocate tags and to determine which tag was preallocated to the load are described below.

Optionally, the release notification is provided by broadcasting it over one or more schedulers and/or one or more threads.

During processing of the second segment, loads in the second segment potentially dependent on the last store are issued only after the release notification is provided. In this way the load does not issue before the last store, regardless of the timing in which the last store in the first segment and load(s) in the second segment were fetched. If the last store is issued before the load is fetched the release notification is provided and the load is issued with no delay. If the load is fetched before the last store is issued, the load is not issued and awaits the release notification.

Optionally, store and load instructions which are suspected will cause an LBS violation are formed into a group. The presence of a load instruction from the second segment in a group shows that the load is potentially dependent on a respective last store identified for the group in the first segment and is required to wait for a release notification from the group's last store. Embodiments of forming groups of load and store instructions are described in more detail below.

Optionally, the release notification is assigned to the last store independently of assigning the loads in the second segment to wait for the release notification. The release notification may be assigned to the last store either before or after the load(s) are assigned to wait for it. However the store and load instructions are connected by the same release notification.

Optionally, during the processing of the second segment instructions and before the last store is decoded in the first segment, the load in segment 2 is set to be released for execution after the release notification is provided.

### Groups

In some embodiments, load and store instructions which previously caused an LBS violation are grouped and a group identifier is assigned to all instructions which are members of the group. The presence of a load or store instruction in a group indicates that it is suspected that the given load or store instruction may cause an LBS violation in the future. In an exemplary embodiment, a group corresponds substantially to the store set described by S. Stone et al. in “Synchronizing Store Sets (SSS): Balancing the Benefits and Risks of Inter-thread Load Speculation”, which is incorporated herein by reference, and is created similarly to Stone's creation of a store set.

As used herein, the term “instruction which is a member of a group”, “instruction in a group” and similar terms means that the instruction (whether load or store) is included in a group with other store and/or load instructions.

Optionally, detecting whether an instruction is a member of a group includes checking whether the instruction has an assigned group identifier, and, further optionally, whether the group identifier is valid.

Optionally, when a load instruction is fetched in the second segment it is first determined if the load instruction is a member of a group, and only load instructions which are a member of a group are required to await a release notification. Further optionally, the load instruction is delayed only if a store instruction which is a member of the same group is present or expected to be present in the first segment.

Optionally, when a load instruction in the second segment is a member of a group, the load instruction is issued for execution if a store instruction in the same group is not present or is not expected to be present in the first segment.

Optionally, a data structure (e.g. table) is used to determine the group identifier assigned to load and store instructions. (Note that not all load and store instructions are necessarily members of a group.) The data structure may be organized in any way known in the art, for example in a set-associative manner.

Table 1 is an exemplary embodiment of a table data structure used for grouping load and store instructions. The instruction identifier points to an instruction in the program code, for example the instruction program counter (PC). The group identifier indicates which group the instruction is a member of. In the example below, PC(N) and PC(N+8) are members of group 4. PC(N+16) is a member of group 3.

Optionally, the table also includes a validity indicator, which shows whether the group identifier is valid. This prevents incorrectly attributing invalid data stored in the table as a group identifier for instructions which are not members of a group.

TABLE 1

| Instruction Identifier | Validity | Group Identifier |
|---|---|---|
| . | . | . |
| . | . | . |
| . | . | . |
| PC(N) | 1 | 4 |
| PC(N + 4) | 0 | |
| PC(N + 8) | 1 | 4 |
| PC(N + 12) | 0 | |
| PC(N + 16) | 1 | 3 |
| . | . | . |
| . | . | . |
| . | . | . |

Optionally, in order to determine if a particular load or store instruction is a member of a group, the instruction identifier for the fetched instruction is used to access a data structure such as Table 1 which holds respective group identifiers. Further optionally, the validity bit is checked and if the validity bit is “0” the instruction is considered to be not associated with a group (therefore if there is a group identifier stored in the table for the given instruction it is not valid). If the instruction is a member of a group, the respective group identifier may be read from the table.

Optionally, the data structure is generated and maintained according to a specified policy. When an LBS violation occurs, entries in the table for the load and store instructions which caused the violation are added or updated according to the policy. In an exemplary embodiment of such a policy:

i) When the PCs associated with the load and store instructions are both new, a new group identifier is assigned to both instructions;

ii) If the load already has a group identifier, then the store is assigned the load's group identifier; and

iii) If the load does not have a group identifier and the store does, then the load gets the store group identifier.

Optionally the groupings are deleted according to a deletion policy, for example on a periodic basis. In this way historic links between load and store instructions are removed, and are restored only if the LBS violation recurs for the same load and store. For example, the groupings may be removed simply by setting the validity bits to False (“0”).

### Handling Load Instructions in the Second Segment

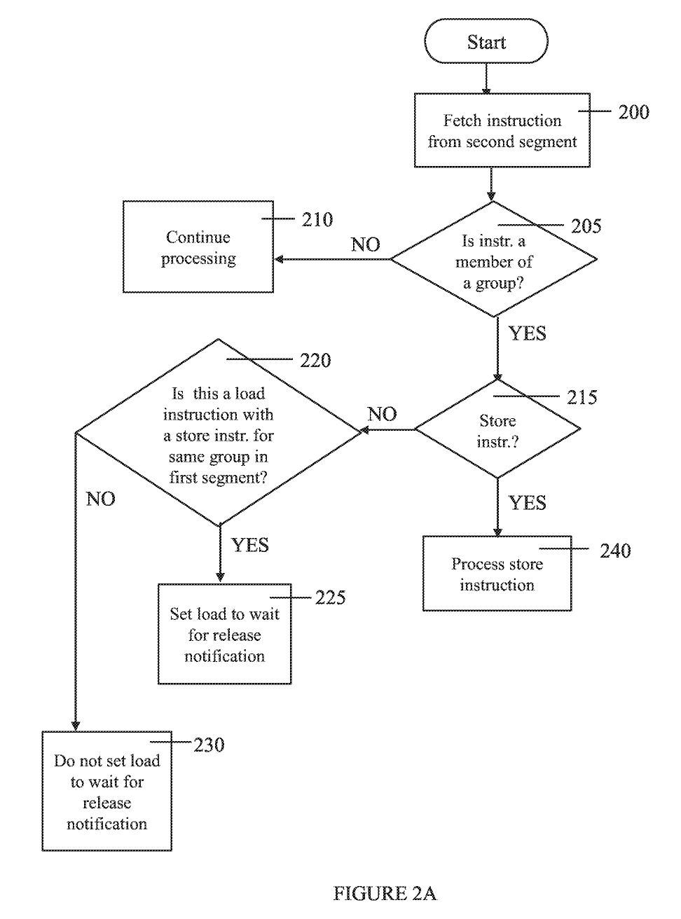

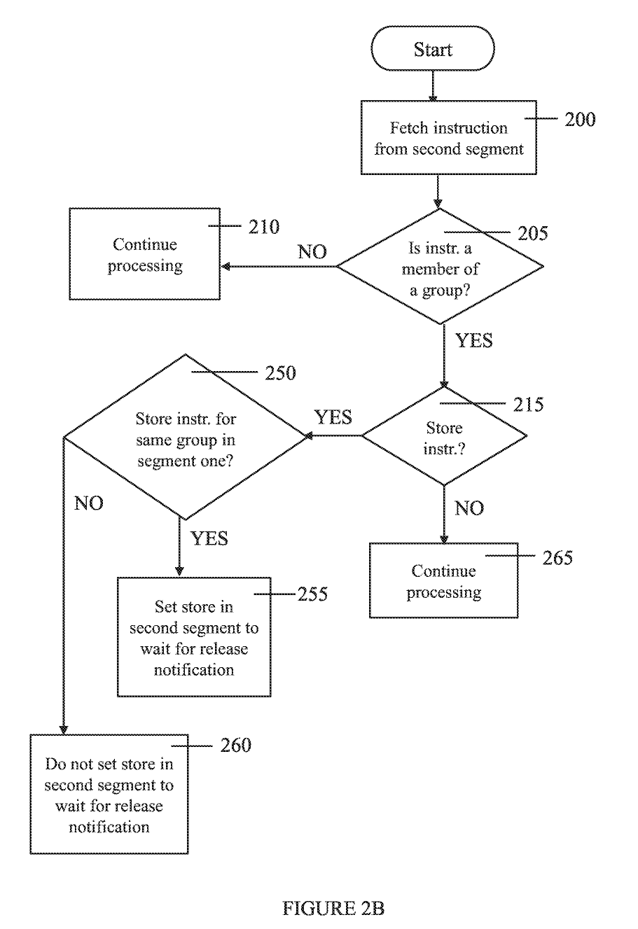

Reference is now made to FIG. 2A, which is a simplified flowchart of managing second segment loads, in accordance with exemplary embodiments of the invention. The exemplary embodiment of FIG. 2A uses groups to determine whether a second segment load should be set to wait for a release notification.

In 200 an instruction is fetched from the second segment.

In 205 it is determined whether the fetched instruction is a member of a group, optionally be checking if the instruction has an assigned group identifier. If the fetched instruction is not a member of a group, there is no need to perform additional actions to prevent an LBS violation and processing continues in 210.

If the fetched instruction is a member of a group, in 215 it is determined whether the instruction is a load or a store.

If the fetched instruction is a load, in 220 it is determined whether there is a store instruction from the same group in segment 1. If there is a store instruction in segment 1, in 225 the load is set to wait for a release notification. If there is not a store instruction in segment 1, in 230 the load is not set to wait for a release notification.

If the fetched instruction is a store, in 240 the store is processed.

### Handling Store Instructions in the Second Segment

In some cases a load in segment 2 may depend on two stores; one in the first segment (denoted herein the first store) and the other in the second segment (denoted herein the second store). To avoid a violation, the load should wait for both stores.

Optionally, a release notification is used in order to require the second store to wait for the first store (similarly to using a release notification for requiring the load in segment 2 to wait for the last store in segment 1). The first store provides a release notification and the second store waits for it.

Reference is now made to FIG. 2B, which is a simplified flowchart of managing second segment stores, in accordance with exemplary embodiments of the invention. The exemplary embodiment of FIG. 2B uses groups to determine whether a second segment store should be set to wait for a release notification.

Steps 200-215 are performed similarly to FIG. 2A.

If the fetched instruction is a store, in 250 it is determined whether there is a store instruction for the same group in segment 1. If there is a store instruction in segment 1, in 255 the store in the segment 2 is set to wait for a release notification. If there is not a store instruction in segment 1, in 260 the store in segment 2 is not set to wait for a release notification.

If the fetched instruction is not a store, processing continues in 265.

Since both the second store and load are in segment 2, prevention of LBS violations between them may be managed by any means known in the art for preventing violations in a single code segment.

### Scoreboard

Optionally, segment 1 is analyzed to count the number of store instructions which are members of the same group are present in the segment. This count may be used to identify the last store instruction when it is fetched during the processing of segment 1.

Optionally, the number of store instructions in segment 1 for each group is counted by one or more of:

i) Analyzing the program code before processing begins;

ii) Analyzing how the instructions were processed before the segments were created (e.g. before multi-thread processing was initiated); and

iii) While the segment is being processed.

A segment may have store and/or load instructions from more than one group (i.e. the segment contains instructions having different assigned group identifiers). Optionally, a respective count is determined for each of the groups.

Optionally, a segment corresponds to a trace stored in the trace database and a scoreboard is maintained for the trace. The scoreboard holds the respective number of store instructions for each group having a store instruction present the segment. Such a scoreboard may be maintained for each trace defined in the program code. Each time the segment is processed the scoreboard is obtained from the trace database.

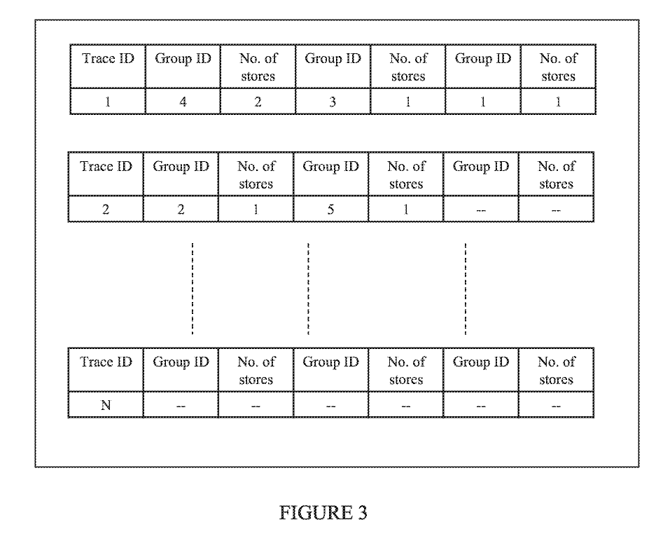

FIG. 3 shows an exemplary embodiment of scoreboards for N traces of the program code. Each scoreboard records the respective number of store instructions for groups associated with the segment.

Optionally, traces in a database are defined and removed dynamically during processing. These changes are reflected also in their associated scoreboards. Optionally, when a trace is removed the trace's scoreboard is deleted. Further optionally, when a new trace is defined a new scoreboard with null data is created. The scoreboard data is updated with respective counts as new LBS events occur during processing of segments associated with respective traces.

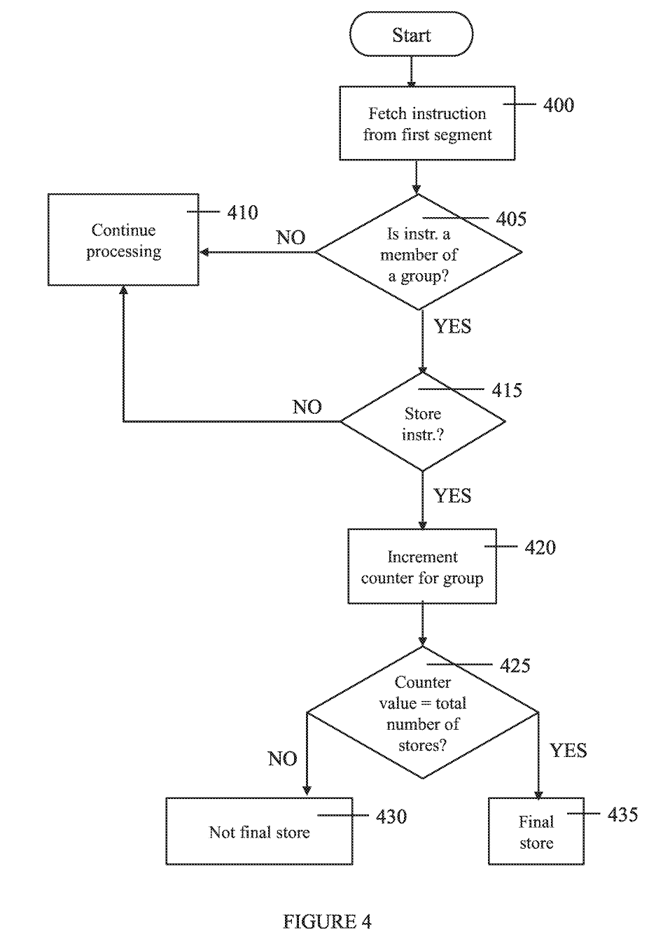

Reference is now made to FIG. 4, which is a simplified flowchart of identifying a last store instruction, in accordance with embodiments of the invention.

In 400 an instruction is fetched in from the first segment.

In 405 it is determined whether the fetched instruction is a member of a group. If the fetched instruction is not a member of a group, there is no need to perform additional actions and processing continues in 410.

If the fetched instruction is associated with a group, in 415 it is determined whether the instruction is a load or a store.

If the fetched instruction is a store, in 420 a respective counter for the group is incremented by one. The counter stores the number of store instructions which have been fetched for the group while the segment is being processed.

In 425, the counter value is compared to the total number of store instructions in the first segment to the memory address being accessed by the store instruction. Optionally, the total number of store instructions is determined from the first segment's scoreboard.

If the counter value is not equal to the total number of store instructions, in 430 the fetched store is not established as the last store. If the counter value is equal to the total number of store instructions, in 435 the fetched store is not established as the last store.

Optionally, a release notification is provided after segment 1 is completely decoded, even if the group's counter value is less than the total number of store instructions for the group (as determined, for example, from the scoreboard). This prevents load(s) in segment 2 from stalling indefinitely due to incorrect processing of the segment 1 instructions (which resulted in fewer store instructions being executed) or due to incorrect data in the scoreboard. Optionally, a respective release notification is provided for each group in which the expected number of stores to the memory address associated with the group did not occur.

Optionally, once segment 1 is completely decoded, if the counter value is different from the number of store instructions of the associated group (either lower or higher), the segment 1 scoreboard is updated with the counter value.

### Tag Maps

Optionally, the release notification is a tag. The same tag is allocated to the last store and to load instruction(s) in segment 2 that are members of the same group. The allocated tag is released when the last store is issued. Loads are issued when it is known that the memory address will be available for second segment loads (and, optionally, second segment stores).

When store and load instructions are grouped, a respective tag is allocated to each group dynamically. Every store that comes into the same group gets a new tag.

Optionally a tag map is maintained for each segment. The tag map stores a respective tag for each group. When a load instruction is decoded, the respective tag is obtained from the tag map. The load instruction is issued if the tag has already been released. If the tag has not yet been released, the load instruction waits for the tag to be released and is issued after release.

Table 2 shows an exemplary tag map for segment M. Segment M has seven possible entries for groups, and tags have been assigned to groups 0 and 1.

TABLE 2

| | Segment | | | | | | |
|---|---|---|---|---|---|---|---|
| | Group 0 | Group 1 | Group 2 | Group 3 | Group 4 | Group 5 | Group 6 |
| 1 | Tag 5 | Tag 6 | NA | NA | NA | NA | NA |

Optionally, an initial tag map is produced for the second segment using the first segment's tag map and scoreboard.

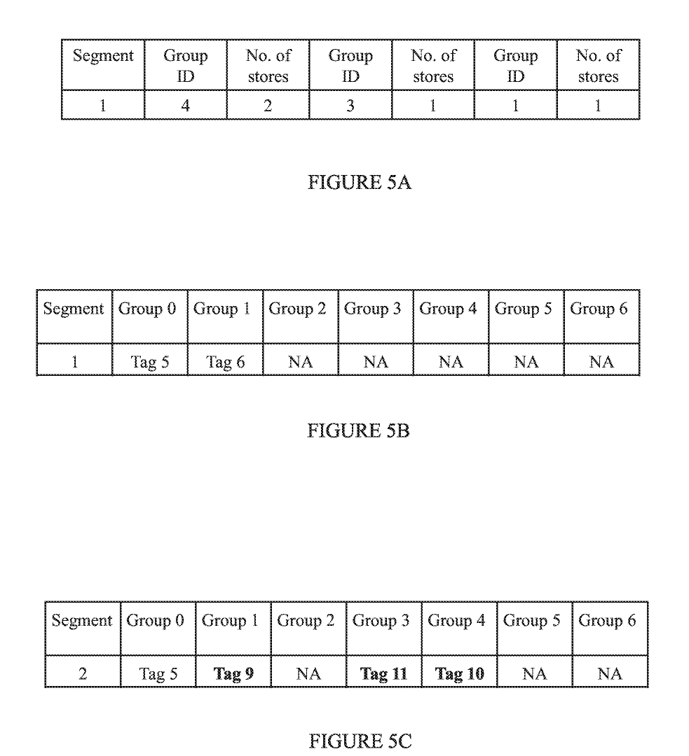

FIGS. 5A-5C illustrate an exemplary technique for producing the initial segment 2 tag map.

Reference is now made to FIG. 5A, which shows an exemplary scoreboard of a trace. Segment 1 is processing this trace and thus uses this scoreboard. As seen from FIG. 5A, stores are executed in segment 1 for groups 4, 3 and 1.

Reference is now made to FIG. 5B, which shows an exemplary tag map for segment 1 (which was built previously, not shown).

Reference is now made to FIG. 5C, which shows an exemplary initial tag map that is built for segment 2, based on segment 1's scoreboard and tag map. Unused tags are assigned to groups 4, 3 and 1. Groups which are not present in segment 1 's scoreboard (or have a count of zero) are assigned the same corresponding tag from in the segment 1 tag map. Therefore the tag for group 0 in the initial segment 2 tag map is assigned as “Tag 5”.

Optionally, after the last store is decoded in the first segment, the last store is assigned the tag that was preallocated to the loads in the second segment. Optionally, when the last store is decoded a check is performed to see if a tag has been preallocated to a load of the group associated with the last store. If a tag has been preallocated, this group's tag is assigned to the last store in the first segment.

For the example in FIGS. 5A-5C, in segment 2's initial tag map group 1 has been assigned a new tag, “Tag 9”. When group 1's last store is decoded in the first segment, “Tag 9” is allocated to it and is released when it is known that the data for the load will be available (e.g. when group 1's last store is issued).

Data Dependency within Segments

Out of order processing within a single segment may also cause LBS violations. The release notification mechanism described above may be used to handle LBS violations within a single segment. For a given group, the respective release notification (e.g. tag) is updated (e.g. in the tag map) every time a store instruction associated with the group is decoded in the first segment. The next load instruction waits for the updated tag before issuing. After the store is issued, the release notification is provided.

### Processor

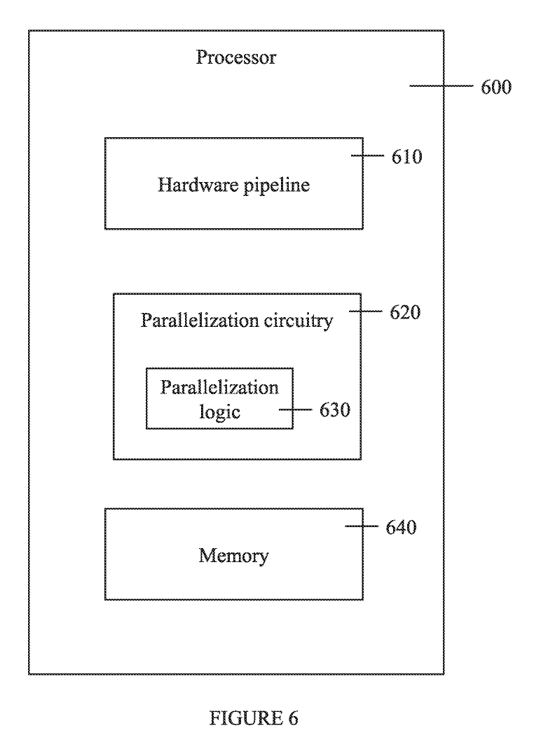

Reference is now made to FIG. 6, which is a simplified block diagram of a processor, in accordance with embodiments of the invention.

Processor 600 includes hardware pipeline 610, which processes a sequence of instructions of program code which include loads and stores to memory addresses. Parallelization circuitry 620 controls loads and stores by hardware pipeline 610 using release notifications as described herein.

Parallelization circuitry 620 creates at least two segments in the instruction sequence. Parallelization circuitry 620 identifies the last store in the first segment. During parallel processing of the segments by hardware pipeline 610, parallelization circuitry 620 controls second segment loads potentially dependent on the last store by:
During processing of the first segment instructions, providing a release notification after the last store is issued for execution; and
During processing of the second segment instructions, issuing the potentially dependent load(s) after the respective release notification is provided.

Optionally parallelization circuitry 620 includes a dedicated processing element (e.g. a second processor) which applies parallelization logic 630 to control hardware pipeline 610. Alternately or additionally, processor 600 devotes its own processing resources to implement embodiments of the invention.

Optionally, data required to implement the embodiments described herein (such as the scoreboards, tag maps, etc.) are stored in the internal processor memory 640. Alternately, some or all of the data is stored in an external memory.

Optionally, parallelization circuitry 620 performs one or more additional functions including but not limited to:

i) Producing and/or maintaining scoreboards;

ii) Producing and/or maintaining tag maps;

iii) Assigning release notifications (e.g. tags);

iv) Assigning a release notification preallocated to loads in the second segment to the last store in the first segment;

v) Providing and/or broadcasting release notifications;

vi) Grouping load and store instructions;

vii) Assigning group identifiers;

viii) Deleting groupings and/or tag mappings and/or scoreboards; and

ix) Incrementing and resetting store instructions counters.

The disclosed embodiments present a straightforward way of reducing the recurrence of LBS violations, both between instructions in different segments of code and within a single section of code. The embodiments are not limited to any particular pipeline or memory structure. The timing of potentially dependent store and load instructions is controlled by a simple release notification technique, which allows the load instruction to be issued as soon as the last store is executed.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant processors, pipelines, parallelized processing techniques, memories, memory load techniques, memory store techniques, program codes, traces and techniques for creating code segments will be developed and the scope of the term processor, pipeline, parallelized processing, memory, memory load, memory store, code, trace and segment is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method comprising:
in a processor that executes program code:
creating a first ordered sequence of instructions of said program code for processing as a first segment and a second ordered sequence of instructions of said program code for processing as a second segment, wherein said second segment is later than said first segment;
identifying, in said first segment, a last store to a memory address, wherein a load in said second segment is potentially dependent on said last store; and
during processing of said first segment and said second segment, executing at least one instruction in said second segment before all instructions in said first segment are decoded and controlling loads potentially dependent on said last store in said second segment, wherein said controlling loads comprises:
during processing of said first segment instructions, providing a release notification when said memory address is available to subsequent instructions; and
during processing of said second segment instructions, issuing said load potentially dependent on said last store for execution after said release notification is provided.

2. A method according to claim 1, wherein said release notification is provided after said last store is issued for execution.

3. A method according to claim 1, further comprising setting, during said processing of said second segment instructions and before said last store is decoded in said first segment, said load potentially dependent on said last store to be released for execution after said release notification is provided.

4. A method according to claim 1, wherein said release notification is assigned to be released after said last store, independently of assigning said release notification to be awaited by said loads.

5. A method according to claim 1, wherein said providing said release notification comprises releasing a tag preallocated to said load potentially dependent on said last store.

6. A method according to claim 1, further comprising determining, for said last store in said first segment, a tag preallocated to said load potentially dependent on said last store.

7. A method according to claim 1, wherein said providing a release notification comprises broadcasting said release notification across at least one of: a plurality of schedulers and a plurality of threads.

8. A method according to claim 1, further comprising:
grouping load and store instructions into at least one group, wherein each group respectively comprises a store and at least one load which together caused a load before store violation; and
assigning, to each instruction in a group, a respective group identifier of said group.

9. A method according to claim 8, further comprising, when a load in said second segment has an assigned group identifier, delaying the issuing of said load for execution only if a store instruction identified by said assigned group identifier is present in said first segment.

10. A method according to claim 8, further comprising analyzing said first segment to determine, for each of said groups, a respective count of store instructions in said first segment to said respective memory address of said group.

11. A method according to claim 8, further comprising, maintaining a store instruction scoreboard for said first segment, wherein said store instruction scoreboard comprises, for each of said groups, a respective count of store instructions of said group in said first segment.

12. A method according to claim 11, wherein said identifying a last store comprises:
fetching a store instruction having an assigned group identifier from said first segment;
incrementing a respective counter for a group identified by said assigned group identifier; and
establishing said fetched store instruction as said last store when a value of said respective counter equals a respective count for said identified group in said scoreboard.

13. A method according to claim 8, further comprising:
maintaining respective tag maps for said first and second segments, wherein a tag map comprises a respective tag for each of said groups; and
after said load is decoded in said second segment, checking said second segment tag map for a respective tag for a group comprising said decoded load and waiting for a release of said respective tag before issuing said decoded load for execution.

14. A method according to claim 8, further comprising:
maintaining respective tag maps for said first and second segments, wherein a tag map comprises a respective tag for each of said groups;
after a store having an assigned group identifier is decoded in said first segment, updating a respective tag of a group identified by said assigned group identifier in said first segment tag map; and
after said decoded store is issued, releasing a notification associated with said respective tag.

15. A method according to claim 14, further comprising, after said last store is decoded, assigning to said last store a respective tag previously allocated in said second segment tag map to said group identified by said assigned group identifier.

16. A method according to claim 14, further comprising producing an initial second segment tag map from said first segment tag map and a store instruction scoreboard for said first segment, wherein said store instruction scoreboard comprises, for each of said groups, a respective count of store instructions for said group in said first segment.

17. A method according to claim 14, further comprising producing an initial second segment tag map from said first segment tag map, said producing an initial second segment tag map comprising:
for each group with store instructions present in said first segment, assigning an unused tag to said group in said second tag map; and
for each group with store instructions absent from said first segment, copying a respective tag of said group in said first segment tag map to said respective tag of said group in said second tag map.

18. A method according to claim 8, further comprising deleting all of said groups according to a deletion policy.

19. A method according to claim 1, further comprising providing said release notification when, after completion of decoding of said first segment, a number of store instructions executed to said memory address is less than a total number of store instructions to said memory address in said first segment.

20. A method according to claim 8, further comprising, for each group, providing a respective release notification when, after completion of decoding of said first segment, a number of executed store instructions for said group is less than a total number of store instructions for said group in said first segment.

21. A processor, comprising:
a hardware-implemented pipeline, configured to process program code;
parallelization circuitry configured to:
create a first ordered sequence of instructions of said program code for processing as a first segment and a second ordered sequence of instructions of said program code for processing as a second segment, wherein said second segment is later than said first segment;
identify, in said first segment, a last store to a memory address, wherein a load in said second segment is potentially dependent on said last store; and
during processing of said first segment and said second segment, execute at least one instruction in said second segment before all instructions in said first segment are decoded and to control loads potentially dependent on said last store in said second segment, said to control loads comprising:
during processing of said first segment instructions, providing a release notification when said memory address is available to subsequent instructions; and
during processing of said second segment instructions, issuing said load potentially dependent on said last store for execution after said release notification is provided.

22. A processor according to claim 21, wherein said parallelization circuitry is further configured to set, during said processing of said second segment instructions and before said last store is decoded in said first segment, said load potentially dependent on said last store to be released for execution after said release notification is provided.

23. A processor according to claim 21, wherein said providing said release notification comprises releasing a tag preallocated to said load potentially dependent on said last store.

24. A processor according to claim 21, wherein said parallelization circuitry is further configured to determine, for said last store in said first segment, a tag preallocated to said load potentially dependent on said last store.

25. A processor according to claim 21, wherein said parallelization circuitry is further configured to:
group load and store instructions into at least one group, wherein each group respectively comprises a store and at least one load which together caused a load before store violation; and
assign, to each instruction in a group, a respective group identifier of said group.

26. A processor according to claim 25, wherein said parallelization circuitry is further configured to maintain a store instruction scoreboard for said first segment, wherein said store instruction scoreboard comprises, for each of said groups, a respective count of store instructions of said group in said first segment.

27. A processor according to claim 25, wherein said parallelization circuitry is further configured to:
maintain respective tag maps for said first and second segments, wherein a tag map comprises a respective tag for each of said groups; and
after said load is decoded in said second segment, to check said second segment tag map for a respective tag for a group identified by a group identifier assigned to said load and to wait for a release of said respective tag before issuing said decoded load for execution.

28. A processor according to claim 25, wherein said parallelization circuitry is further configured to:
maintain respective tag maps for said first and second segments, wherein a tag map comprises a respective tag for each of said groups;
after a store having an assigned group identifier is decoded in said first segment, to update said respective tag of a group identified by a group identifier assigned to said store in said first segment tag map; and
after said decoded store is issued, to release a notification associated with said respective tag.

29. A processor according to claim 28, wherein said parallelization circuitry is further configured to assign to said last store, after said last store is decoded, a respective tag previously allocated in said second segment tag map to said group identified by said assigned group identifier store.

30. A processor according to claim 28, wherein said parallelization circuitry is further configured to produce an initial second segment tag map from said first segment tag map, said producing an initial second segment tag map comprising:
for each group with store instructions present in said first segment, assigning an unused tag to said group in said second tag map; and
for each group with store instructions absent from said first segment, copying a respective tag of said group in said first segment tag map to said respective tag of said group in said second tag map.

31. A processor according to claim 21, wherein said parallelization circuitry is further configured to provide said release notification when, after completion of decoding of said first segment, a number of store instructions executed to said memory address is less than a total number of store instructions to said memory address in said first segment.

32. A method comprising:
in a processor that executes program code:
creating a first ordered sequence of instructions of said program code as a first segment and a second ordered sequence of instructions of said program code for processing as a second segment, wherein said second segment is later than said first segment;
identifying, in said first segment, a last store to a memory address, wherein a store in said second segment is potentially dependent on said last store in said first segment; and
during processing of said first segment and said second segment, executing at least one instruction in said second segment before all instructions in said first segment are decoded and controlling second segment stores potentially dependent on said last store, wherein said controlling second segment stores comprises:
during processing of said first segment instructions, providing a release notification when said memory address is available to subsequent instructions; and
during processing of said second segment instructions, issuing said second segment store potentially dependent on said last store for execution after said release notification is provided.

33. A method according to claim 32, wherein said second segment comprises a load potentially dependent on said last store, said method further comprising: preventing load before store violations in said second segment between said load potentially dependent on said last store and store potentially dependent on said last store.
